(19) United States
(12) Patent Application Publication
(10) Pub. No.: US 2017/0094067 A1
(43) Pub. Date: Mar. 30, 2017

(54) DATA COMMUNICATION CONTROL DEVICE, IMAGE READING DEVICE, AND IMAGE FORMING APPARATUS

(71) Applicant: FUJI XEROX CO., LTD., Tokyo (JP)

(72) Inventors: Yujin ISHI, Kanagawa (JP); Kazuaki SHINTANI, Kanagawa (JP)

(73) Assignee: FUJI XEROX CO., LTD., Tokyo (JP)

(21) Appl. No.: 15/018,176

(22) Filed: Feb. 8, 2016

(30) Foreign Application Priority Data
Sep. 25, 2015 (JP) 2015-188630

(51) Int. Cl. H04N 1/00; H04N 1/50; H04B 1/40; H04N 1/23

(52) U.S. Cl. CPC H04N 1/001; H04N 1/0032; H04N 1/00795; H04N 1/23; H04N 1/50; H04N 1/0057; H04B 1/40; H04N 2201/0091

(57) ABSTRACT

A data communication control device includes a transmitting unit that transmits data; and a receiving unit that receives the data through a communication line. The transmitting unit includes a transmitting component that transmits an establishment signal of establishing communication to transmit the data to the receiving unit, and a first controller that controls the transmitting component. The receiving unit includes a receiving component that receives the data transmitted by the transmitting component, and outputs a confirmation signal of confirming the establishment of the data communication with the transmitting component when receiving the establishment signal, and a second controller that controls the receiving component, and transmits a notification signal of notifying the first controller about the establishment of the data communication through a dedicated line different from the communication line when receiving the confirmation signal. The transmitting component starts transmitting the data when the first controller receives the notification signal.

### CROSS-REFERENCE TO RELATED APPLICATIONS

This application is based on and claims priority under 35 USC 119 from Japanese Patent Application No. 2015-188630 filed Sep. 25, 2015.

### BACKGROUND

The present invention relates to a data communication control device, an image reading device, and an image forming apparatus.

### SUMMARY

According to an aspect of the invention, there is provided a data communication control device including a transmitting unit that transmits data; and a receiving unit that receives the data through a communication line. The transmitting unit includes a transmitting component that transmits an establishment signal of establishing communication to transmit the data to the receiving unit through the communication line, and a first controller that controls the transmitting component. The receiving unit includes a receiving component that receives the data transmitted by the transmitting component, and outputs a confirmation signal of confirming the establishment of the data communication with the transmitting component when receiving the establishment signal, and a second controller that controls the receiving component, and transmits a notification signal of notifying the first controller about the establishment of the data communication through a dedicated line different from the communication line when receiving the confirmation signal input from the receiving component. The transmitting component starts transmitting the data when the first controller receives the notification signal.

### BRIEF DESCRIPTION OF THE DRAWINGS

Exemplary embodiments of the present invention will be described in detail based on the following figures, wherein:

FIG. 1 is a general configuration diagram showing an image forming apparatus to which a data communication control device and an image reading device according to a first exemplary embodiment of the invention are applied;

FIG. 2 is a configuration diagram showing the image reading device according to the first exemplary embodiment of the invention;

FIG. 3 is a configuration diagram showing an image reading unit;

FIG. 4 is a cross-sectional configuration diagram showing the image reading unit;

FIG. 5 is a block diagram showing the image reading device to which the data communication control device according to the first exemplary embodiment of the invention is applied;

FIG. 6 is a timing chart showing an operation of the image reading device to which the data communication control device according to the first exemplary embodiment of the invention is applied;

FIG. 7 is a block diagram showing an operation of an image reading device to which a data communication control device of related art is applied;

FIG. 8 is a block diagram showing an image reading device to which a data communication control device according to a second exemplary embodiment of the invention is applied;

FIG. 9 is a circuit diagram showing a logic circuit;

FIG. 10 is a timing chart showing an operation of the image reading device to which the data communication control device according to the second exemplary embodiment of the invention is applied;

FIG. 11 is a block diagram showing an image reading device to which a data communication control device according to a third exemplary embodiment of the invention is applied; and

FIG. 12 is a block diagram showing an image reading device to which a data communication control device according to a fourth exemplary embodiment of the invention is applied.

### DETAILED DESCRIPTION

Exemplary embodiments of the invention are described below with reference to the drawings.

### First Exemplary Embodiment

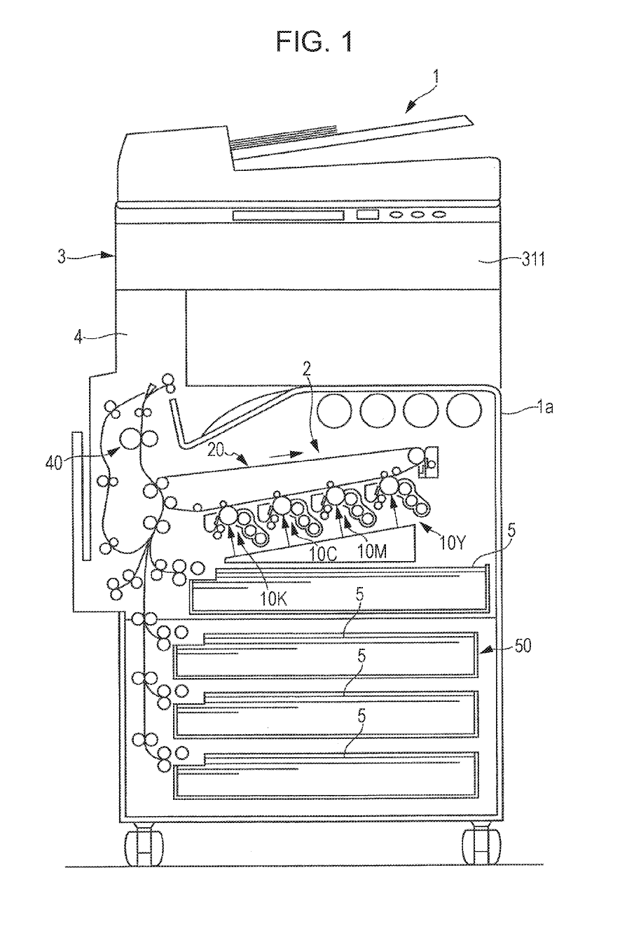

FIG. 1 is a configuration diagram showing an overview of an image forming apparatus to which a data communication control device and an image reading device according to a first exemplary embodiment of the invention are applied.

### General Configuration of Image Forming Apparatus

As shown in FIG. 1, an image forming apparatus 1 according to the first exemplary embodiment is formed as, for example, a color copier. The image forming apparatus 1 includes an image reading device 3 that reads an image of a document, and an image forming unit 2 serving as an example of an image forming section that forms an image on a recording medium in accordance with image data or the like read by the image reading device 3. The image reading device 3 is arranged above an apparatus body 1a in a manner supported by a support 4. The apparatus body 1a houses the image forming unit 2. A space for outputting the recording medium with the image formed thereon is formed between the image reading device 3 and the apparatus body 1a.

The image forming unit 2 includes four image forming devices 10Y, 10M, 10C, and 10K that respectively dedicatedly form toner images of four colors of yellow (Y), magenta (M), cyan (C), and black (K); an intermediate transfer device 20 that carries the toner images respectively formed by the image forming devices 10Y, 10M, 10C, and 10K and transports the toner images to a second transfer position at which the intermediate transfer device 20 finally second transfers the toner images on a recording paper 5 being an example of a recording medium; a paper feed device 50 that houses a predetermined recording paper 5 to be fed to the second transfer position of the intermediate transfer device 20 and transports the recording paper 5; and a fixing device 40 that fixes the toner images on the recording paper 5 second transferred by the intermediate transfer device 20.

### Configuration of Image Reading Device

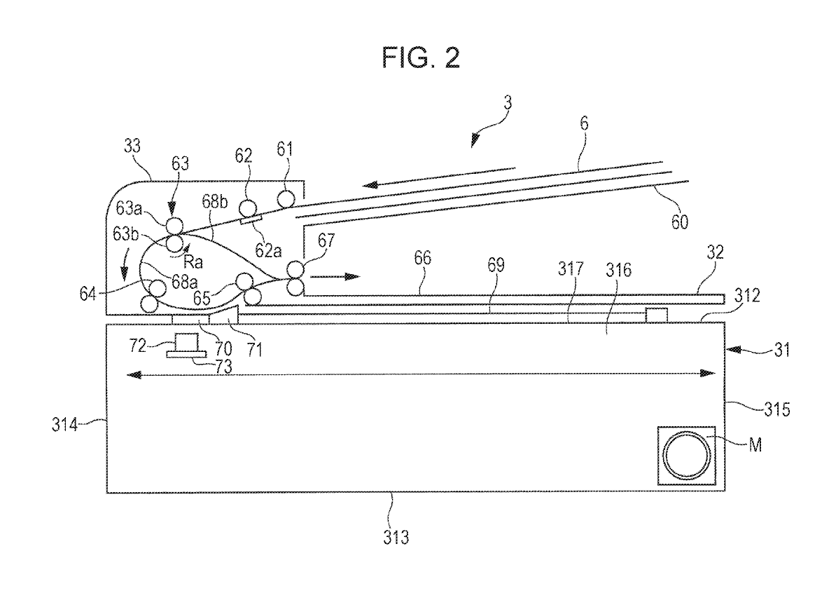

FIG. 2 is a schematic configuration diagram showing the image reading device according to the first exemplary embodiment of the invention.

The image reading device 3 roughly includes a housing 31 having a document reading surface at an upper end surface of the housing 31, a document press covering 32 attached to the housing 31 in an openable and closable manner, and a duplex automatic document feeder (DADF) 33 provided at one end portion (in the drawing example, a left end portion) of the document press covering 32.

The image reading device 3 may be switched between a first reading mode, in which images on the front and back surfaces of documents 6 are read while the documents 6 are automatically transported one by one by the DADF 33, and a second reading mode, in which an image on a document 6 placed on a document table 69 (described later) is read.

The DADF 33 has a document transport mechanism (a transport unit) including a document housing part 60 that is able to house plural documents 6 in a stacked manner with surfaces to be read (first surfaces) facing upward; a nudger roller 61 that sends the documents 6 from the document housing part 60; a feed roller 62 that separates and feeds the documents 6 sent by the nudger roller 61 one by one; a retard pad 62a that is pressed by the feed roller 62 and separates the documents 6 one by one; a first transport roller 63 that transports the document 6 toward a first reading position; a second transport roller 64 that transports the document 6 transported by the first transport roller 63 to the first reading position; a third transport roller 65 that is arranged downstream of the second transport roller 64 and transports the document 6 which has passed through the first reading position; and an output roller 67 that outputs the document 6 transported by the third transport roller 65 to an output housing part 66 or reverses the front and back surfaces of the document 6 by reversing a rotation direction and transports the document 6 again to the first transport roller 63. The nudger roller 61, the feed roller 62, the first to third transport rollers 63 to 65, and the output roller 67 are driven by a driving part (not shown) while the document 6 is read. The first transport roller 63 is a registration roller that adjusts a transport timing to the reading position of the document 6.

In the first transport roller 63, while a transport roller 63b serving as a driving roller arranged at the lower side and being rotatable in a direction indicated by arrow Ra stops, the leading edge of the document 6 transported by the feed roller 62 positioned at the upstream side in a transport direction of the document 6 contacts a contact part between the transport roller 63b and a transport roller 63a serving as a driven roller. Then, the first transport roller 63 executes skew correction by curving a leading edge region of the document 6, aligning the leading edge of the document 6 with the axial direction of the first transport roller 63, and then starting transport of the document 6.

Also, the DADF 33 includes a curved transport path 68a that guides the document 6 to the first reading position and guides the document 6 from the first reading position in an output direction, and a reverse transport path 68b that reverses the front and back surfaces of the document 6 and transports the document 6 to the first reading position again.

The housing 31 of the image reading device 3 is formed in a rectangular-parallelepiped-shaped box having an opening at a portion of an upper end surface of the box. The housing 31 includes an upper wall 312 facing the document press covering 32, a bottom wall 313 facing the upper wall 312, a side wall 314 and a side wall 315 facing each other along a sub-scanning direction (a left-right direction in FIG. 2) with the bottom wall 313 interposed therebetween, a front wall 311 (see FIG. 1) positioned at a front surface of the housing 31, and a rear wall 316 facing the front wall 311 in a main-scanning direction (a direction orthogonal to the paper face of FIG. 2).

The upper wall 312 of the housing 31 has a large opening 317 having a planar rectangular shape at a portion corresponding to a second reading position for the document 6 to be read in the second reading mode. The transparent document table 69 (platen glass) that supports the document 6 is arranged at the opening 317. Also, a transparent reading window 70 for reading the document 6 in the first reading mode is provided at the DADF 33 side of the document table 69. A guide member 71 is provided between the reading window 70 and the document plate 69. The guide member 71 has an inclined upper surface that guides the document 6, which has passed through the reading position in the first reading mode, to the third transport roller 65.

The image reading device 3 includes an image reading unit 72 serving as an example of an image reading section that reads the image of the document 6, in the housing 31. The image reading unit 72 is arranged along the main-scanning direction (the direction orthogonal to the drawing). Also, the image reading unit 72 is attached to a movable body 73 formed of a carriage that is movable along the sub-scanning direction by a driving motor M through a driving pulley, a driving wire, etc. (not shown). The movable body 73 is guided by a rail (not shown) and is movable in a region indicated by arrows in FIG. 2 along the sub-scanning direction. The movable body 73 is stopped at the illustrated position in the first reading mode. Also, in the second reading mode, the movable body 73 reads the image of the document 6 while moving along the sub-scanning direction and illuminating a reading target region of the document 6 placed on the document table 69.

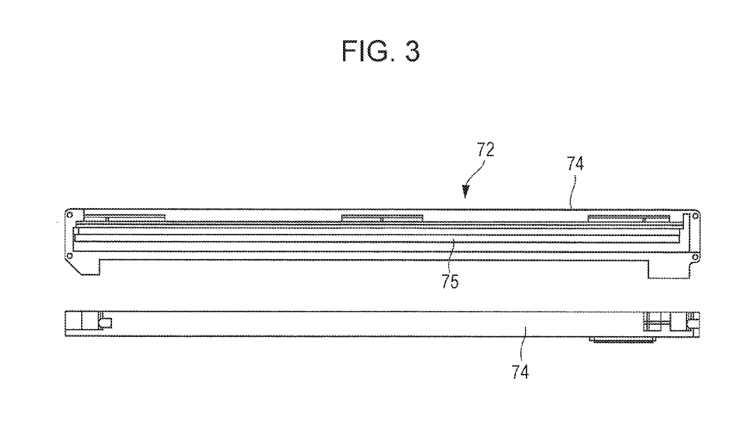

For the image reading unit 72, for example, a contact image sensor (CIS) is used. As shown in FIG. 3, the image reading unit 72 has a narrow and long rectangular-parallelepiped shape having a rectangular cross section with a length corresponding to the short side direction or the long side direction of the document 6 with A4 size (210×297 mm). The image reading unit 72 has a housing 74 and an opening 75 at an upper end surface of the housing 74. The opening 75 allows the image of the document 6 to be read while the document 6 is illuminated with light.

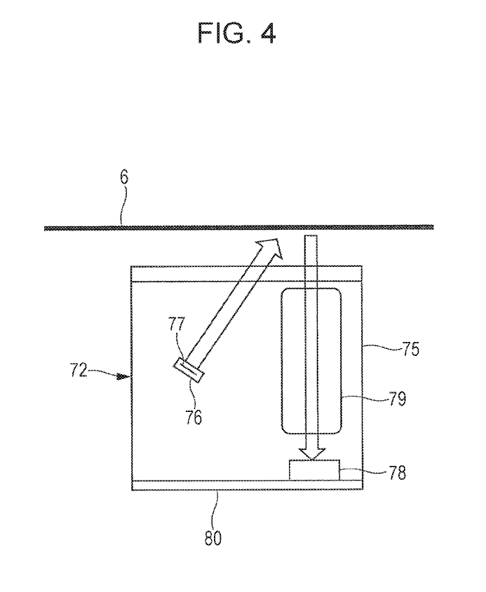

More specifically, as shown in FIG. 4, the image reading unit 72 includes a light source 76 serving as an example of an illuminator formed of a light emitting diode (LED) that illuminates the document 6, a diffuser 77 that diffuses the light emitted from the light source 76 toward the document 6 to uniformly illuminate the document 6, a SELFOC (registered trademark) lens 79 serving as an imaging lens that causes the image of the document 6 to be focused on an image reading element 78, and the image reading element 78 formed of a charge-coupled device (CCD) or the like that reads the image of the document 6. The image reading element 78 is mounted on an image reading substrate 80 serving as an example of a transmitting unit. The image reading element 78 is not limited to the CCD, and a complementary metal oxide semiconductor (CMOS) or the like may be used.

In the first reading mode, as shown in FIG. 2, the DADF 33 automatically transports the document 6 while the movable body 73 is stopped at the first reading position set at the left end portion of the housing 31. As shown in FIG. 4, in the image reading unit 72, while the document 6 passing through the position above the reading window 70 is illuminated with light by the light source 76, a reflection light image from the document 6 is focused on the image reading element 78 through the SELFOC (registered trademark) lens 79, and the image of the document 6 is read by the image reading element 78. The image reading element 78 outputs image data (a signal) of the read document 6.

In contrast, in the second reading mode, as shown in FIG. 2, while the movable body 73 is driven by the driving motor M and the movable body 73 moves along the sub-scanning direction, the document 6 is illuminated with light by the light source 76 of the image reading unit 72. In the image reading unit 72, as shown in FIG. 4, a reflection light image from the document 6 is focused on the image reading element 78 through the SELFOC (registered trademark) lens 79, the image of the document 6 is read by the image reading element 78, and image data is output from the image reading element 78.

### Configuration of Major Section of Image Reading Device

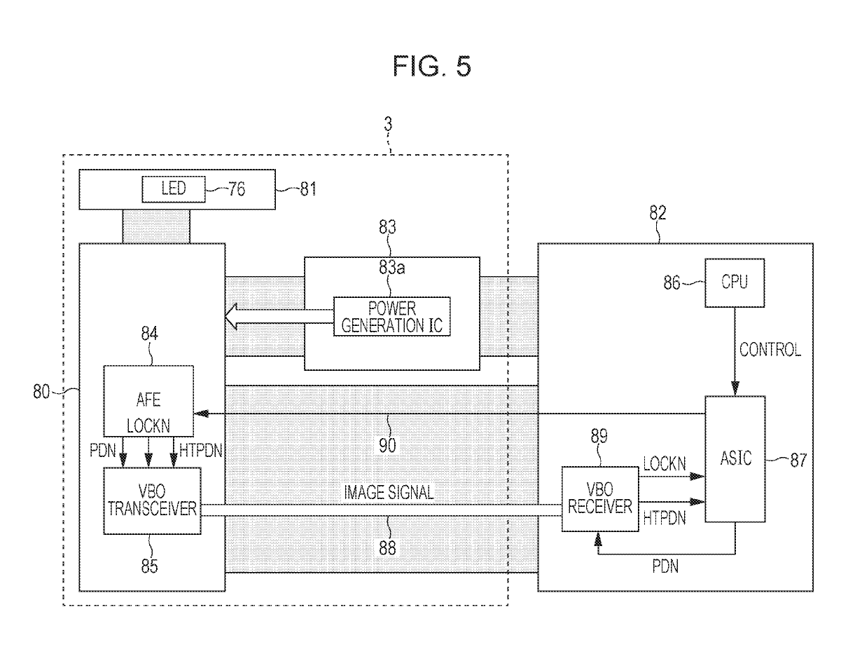

As shown in FIG. 5, the image forming apparatus 1 including the image reading device 3 according to the first exemplary embodiment includes the image reading substrate 80 serving as an example of a transmitting unit mounted with the image reading element 78, an LED substrate 81 connected to the image reading substrate 80 and having an LED as the light source 76, a control substrate 82 serving as an example of a receiving unit, and a power supply substrate 83 that supplies a predetermined direct-current (DC) voltage to the image reading substrate 80 and the control substrate 82. The control substrate 82 is provided, for example, in the apparatus body 1a of the image forming apparatus 1 or the housing 31 of the image reading device 3.

The image reading substrate 80 includes an analog front end (AFE) 84 serving as an example of a first controller that amplifies image data formed of analog signals of three colors including red (R), green (G), and blue (B) output from the image reading element 78, removes noise, and converts the analog signals into digital signals, and a V-by-One (VBO) system transceiver 85 serving as an example of a transmitting component that transmits the image data output from the AFE 84 to the control substrate 82. The V-by-One (VBO) system is a high-speed serial interface technique for image transmission developed by THine Electronics, Inc. The V-by-One (VBO) system has a signal frequency of the image reading substrate 80 being as very high as about 1 GHz. This high-speed signal is able to be transmitted by a distance that is as long as several meters by a pair of differential signal lines. Also, the V-by-One (VBO) system employs a system that has a markedly smaller number of cables required for communication of image data as compared with parallel transmission system and that transmits clock and data in a superposed manner. The AFE 84 of the image reading substrate 80 has a function as a central processing unit (CPU). The AFE 84 also has a communication function. The AFE 84 of the image reading substrate 80 outputs a PDN signal (a power ON control signal for the transceiver and a receiver, described later), an HTPDN signal (a power ON detection signal of the receiver), and an LOCKN signal (a communication establishment detection signal with the receiver), to the VBO transceiver 85.

The power supply substrate 83 includes a power generation integrated circuit (IC) 83a. The power supply substrate 83 supplies a predetermined DC voltage, such as 3 V, 12 V, or 24 V, or a current to the image reading substrate 80 and the control substrate 82 at a predetermined timing.

Also, the control substrate 82 includes a CPU 86 that controls the image reading device 3, an application specific integrated circuit (ASIC) 87 serving as an example of a second controller that is controlled by the CPU 86 and executes (controls) communication etc. with respect to the image reading substrate 80, and a VBO receiver 89 of VBO system serving as an example of a receiving component connected to the VBO transceiver 85 of the image reading substrate 80 through a communication cable 88 serving as an example of a communication line. The communication cable 88 may be, for example, a flexible flat cable. Also, the ASIC 87 is connected to the AFE 84 of the image reading substrate 80 through a dedicated line 90 in a manner available for serial communication. The dedicated line 90 may be an independent signal line or a portion of the communication cable 88.

The CPU 86 is connected to a read only memory (ROM), a random access memory (RAM), etc., through a bus (not shown), and controls the operation of the image reading device 3 on the basis of a program stored in the ROM.

Also, the ASIC 87 is controlled by the CPU 86, outputs the PDN signal (the power ON control signal of the transceiver and the receiver) to the VBO receiver 89, and receives the HTPDN signal (the power ON detection signal of the receiver) and the LOCKN signal (the communication establishment detection signal with the receiver) input from the VBO receiver 89.

### Operation of Major Section of Image Reading Device

In the image reading device 3 according to the first exemplary embodiment, the image data of the document 6 read by the image reading element 78 of the image reading unit 72 is transmitted from the image reading substrate 80 to the control substrate 82 as follows.

In the image reading device 3, as shown in FIG. 5, when reading the image of the document 6 is instructed in the image forming apparatus 1, the power supply substrate 83 supplies power to the image reading substrate 80 and the control substrate 82.

As shown in FIG. 2, the image reading device 3 stops the image reading unit 72 at a predetermined position or moves the image reading unit 72 along the sub-scanning direction and the image reading unit 72 reads the image of the document 6 in accordance with the first or second reading mode.

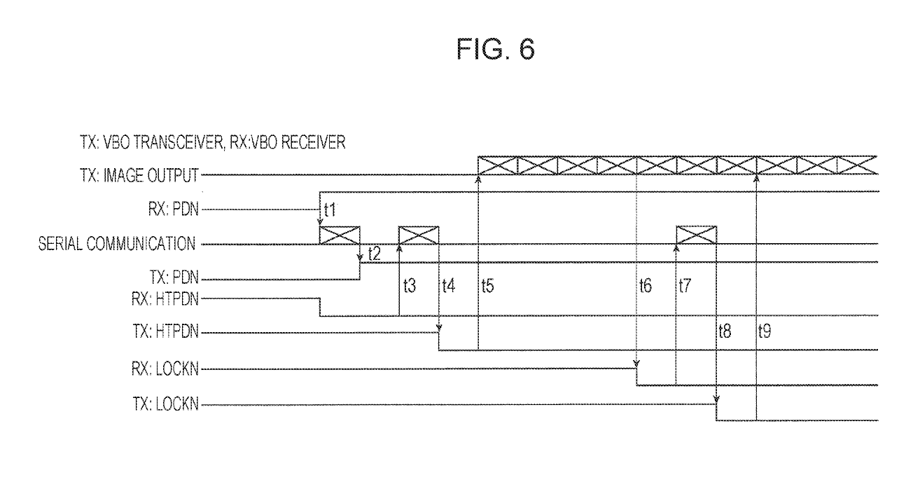

At this time, the image reading substrate 80 mounted on the image reading unit 72 executes an establishment operation of data communication with respect to the control substrate 82 through the communication cable 88 before transmission of image data based on an image reading operation. As shown in FIG. 6, the ASIC 87 of the control substrate 82 switches the PDN signal (the power ON control signal of the receiver) output to the VBO receiver 89 to High, and notifies the AFE 84 of the image reading substrate 80 about that the PDN signal (the power ON control signal of the receiver) is High by the serial communication through the communication cable 88 (timing t1). Also, the ASIC 87 of the control substrate 82 switches the HTPDN signal (the power ON detection signal) output from the VBO receiver 89 to Low simultaneously when the PDN signal (the power ON control signal) of the VBO receiver 89 becomes High. The HTPDN signal (the power ON detection signal) etc. is previously held High by a power supply device (not shown) of the image forming apparatus 1.

The AFE 84 of the image reading substrate 80 drives the PDN signal (the power ON control signal) of the VBO transceiver 85 to High simultaneously when the AFE 84 receives the notification about that the PDN signal (the power ON control signal of the receiver) is High from the control substrate 82 (timing t2).

Then, when the ASIC 87 of the control substrate 82 detects that the HTPDN signal (the power ON detection signal of the receiver) output from the VBO receiver 89 becomes Low, the ASIC 87 notifies the AFE 84 of the image reading substrate 80 about that the HTPDN signal (the power ON detection signal of the receiver) is Low by the serial communication through the communication cable 88 (timing t3).

Then, the AFE 84 of the image reading substrate 80 switches the HTPDN signal (the power ON detection signal) of the VBO transceiver 85 to Low on the basis of the serial communication with the control substrate 82 (timing t4). Then, when the VBO transceiver 85 of the image reading substrate 80 detects that the HTPDN signal (the power ON detection signal of the transceiver) is switched to Low, the VBO transceiver 85 starts an operation of transmitting a predetermined test pattern serving as an example of an establishment signal of VBO system to the control substrate 82 through the communication cable 88 (timing t5).

When the ASIC 87 of the control substrate 82 correctly detects the test pattern serving as the example of the establishment signal of VBO system received through the VBO receiver 89, the ASIC 87 switches the LOCKN signal (the communication establishment detection signal) serving as an example of a confirmation signal output to the image reading substrate 80 through the dedicated line 90 to Low (timing t6).

Then, when the ASIC 87 of the control substrate 82 detects that the LOCKN signal (the communication establishment detection signal) becomes Low, the ASIC 87 notifies the AFE 84 of the image reading substrate 80 about that the LOCKN signal (the communication establishment detection signal) serving as an example of a notification signal by the serial communication through the dedicated line 90 (timing t7).

Then, when the AFE 84 of the image reading substrate 80 receives the notification about that the LOCKN signal (the communication establishment detection signal) becomes Low, the AFE 84 switches the LOCKN signal (the communication establishment detection signal) of the VBO transceiver 85 to Low (timing t8).

Then, when the VBO transceiver 85 of the image reading substrate 80 detects that the LOCKN signal (the communication establishment detection signal) serving as the example of the notification signal is Low by the serial communication, the VBO transceiver 85 starts transmission (output) of the image data of the document 6 read by the image reading element 78 (timing t9).

As described above, in the image reading device 3 according to the first exemplary embodiment, the serial communication is executed between the AFE 84 of the image reading substrate 80 and the ASIC 87 of the control substrate 82. If it is detected that the LOCKN signal (the communication establishment detection signal) serving as the example of the notification signal is Low by the serial communication, the transmission (output) of the image data of the document 6 read by the image reading element 78 is started. Hence, to establish the data communication between the image reading substrate 80 of the image reading device 3 and the control substrate 82, it may be detected that the LOCKN signal (the communication establishment detection signal) serving as the example of the notification signal is Low by the serial communication through the dedicated line 90. Therefore, the image reading substrate 80 of the image reading device 3 and the control substrate 82 may be connected through the dedicated line 90. This decreases the number of transmission paths for transmitting the same control signal, as compared with a case in which control is normally executed on the basis of plural control signals input through plural transmission paths. Also, the image reading substrate 80 of the image reading device 3 and the control substrate 82 may detect that the LOCKN signal (the communication establishment detection signal) is Low by the serial communication through the dedicated line 90. This may reduce the influence of noise.

### COMPARATIVE EXAMPLE

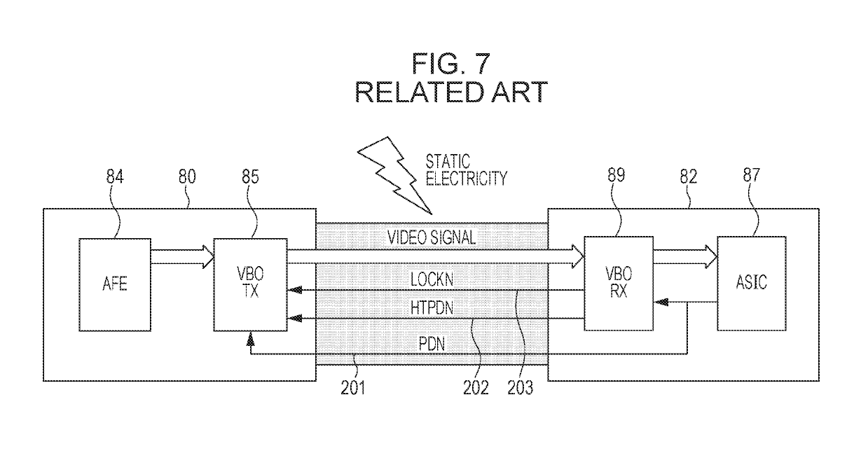

FIG. 7 is a block diagram showing a control circuit of an image reading device of related art.

As shown in FIG. 7, in the image reading device of related art, the PDN signal (the power ON control signal of the transceiver and the receiver) is output from the ASIC 87 of the control substrate 82 to the VBO receiver 89 and the VBO transceiver 85 of the image reading substrate 80 through a DC line 201, and the HTPDN signal (the power ON control signal of the receiver) and the LOCKN signal (the communication establishment detection signal with the receiver) are output from the VBO receiver 89 of the control substrate 82 to the VBO transceiver 85 of the image reading substrate 80 through DC lines 202 and 203, so that communication is established for image data between the VBO transceiver 85 of the image reading substrate 80 and the VBO receiver 89 of the control substrate 82.

Hence, In the case of related art shown in FIG. 7, the image reading substrate 80 is connected to the control substrate 82 through the DC lines 201 to 203 that transmit the PDN signal (the power ON control signal of the receiver), the HTPDN signal (the power ON detection signal of the receiver), and the LOCKN signal (the communication establishment detection signal). This increases the number of DC lines. Also, in the case of related art shown in FIG. 7, under a low-temperature low-humidity environment, if noise such as static electricity is superposed on the DC lines 201 to 203 that transmit the PDN signal (the power ON control signal of the receiver), the HTPDN signal (the power ON detection signal of the receiver), and the LOCKN signal (the communication establishment detection signal), the PDN signal (the power ON control signal of the receiver), the HTPDN signal (the power ON detection signal of the receiver), or the LOCKN signal (the communication establishment detection signal) has to be transmitted again to establish communication between the image reading substrate 80 and the control substrate 82. If noise acts during the image reading operation, an image defect may occur in plural lines of the image read by the image reading element 78 for a time period required for the re-establishment of the communication.

In contrast, in the case of the above-described exemplary embodiment, since the establishment of the communication between the VBO transceiver 85 of the image reading substrate 80 and the VBO receiver 89 of the control substrate 82 is executed by the serial communication through the communication cable 88 as described above, even if electrostatic noise occurs, the communication establishment operation is executed again by the serial communication. Accordingly, receiving the influence of electrostatic noise may be avoided.

Also, after the communication is established between the VBO transceiver 85 of the image reading substrate 80 and the VBO receiver 89 of the control substrate 82, the AFE 84 of the image reading substrate 80 may hold the information on the communication establishment. Accordingly, receiving the influence of electrostatic noise may be avoided.

### Second Exemplary Embodiment

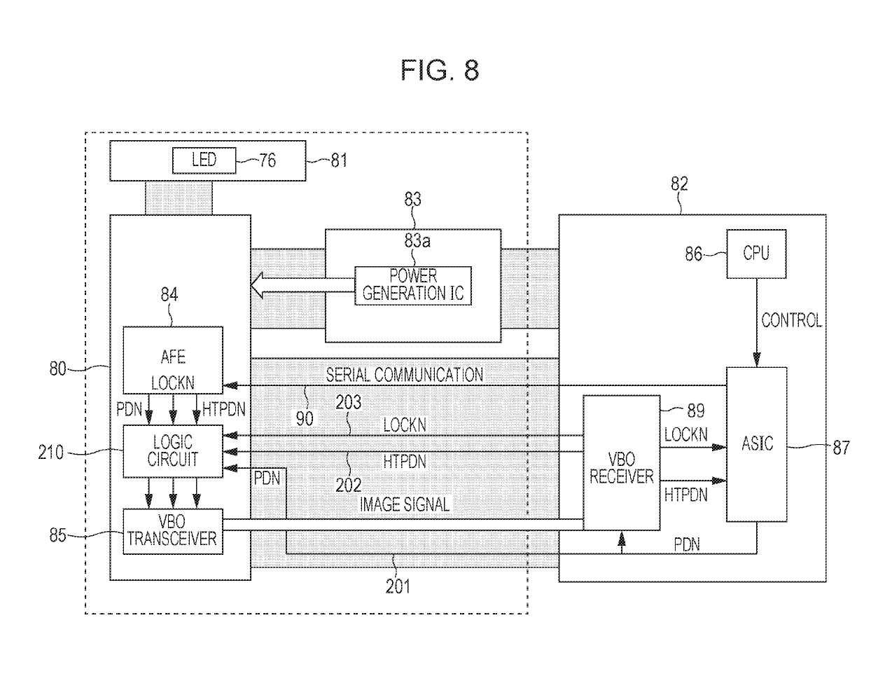

FIG. 8 is a block diagram showing an image reading device to which a data communication control device according to a second exemplary embodiment of the invention is applied.

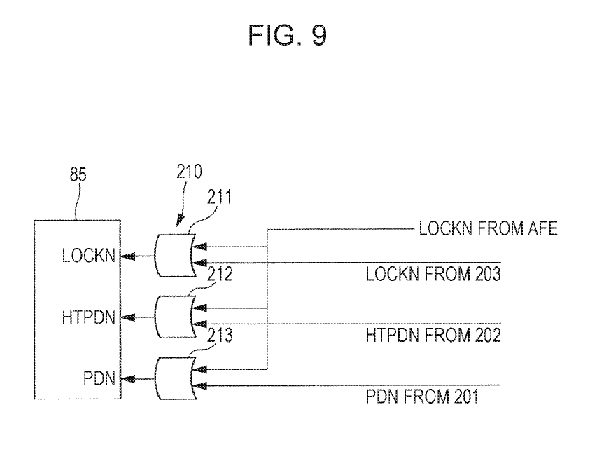

In this exemplary embodiment, as shown in FIG. 8, there are included DC lines 201 to 203 that connect the image reading substrate 80 and the control substrate 82, and a logic circuit 210 serving as an example of an output component. The logic circuit 210 is provided on the image reading substrate 80, and outputs the notification signal received by the AFE 84 through the dedicated line 90, or at least one of the PDN signal (the power ON control signal of the receiver), the HTPDN signal (the power ON detection signal of the receiver), and the LOCKN signal (the communication establishment detection signal). As shown in FIG. 9, the logic circuit 210 includes three OR circuits 211 to 213 that each receive the LOCKN signal (the communication establishment detection signal) output from the AFE 84, or corresponding one of the PDN signal (the power ON control signal of the receiver), the HTPDN signal (the power ON detection signal of the receiver), and the LOCKN signal (the communication establishment detection signal) output from the control substrate 82.

In the case of the first exemplary embodiment shown in FIG. 5, as shown in FIG. 6, it is required to execute the communication by the serial communication when the data communication is established between the image reading substrate 80 and the control substrate 82. It may be delayed to start transmitting the image data from the image reading substrate 80.

Hence, in the case of the second exemplary embodiment, the image reading substrate 80 is connected to the control substrate 82 through the DC lines 201 to 203.

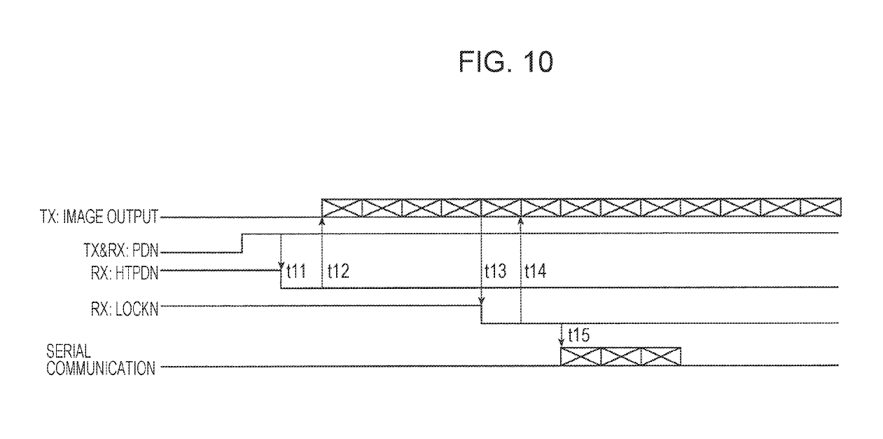

In the second exemplary embodiment, as shown in FIG. 10, to establish the data communication between the image reading substrate 80 and the control substrate 82, the PDN signal (the power ON control signal of the receiver), the HTPDN signal (the power ON detection signal of the receiver), and the LOCKN signal (the communication establishment detection signal) may be sequentially received through the DC lines 201 to 203 (timing t11 to timing t15). The data communication may be established between the image reading substrate 80 and the control substrate 82 at early timing.

Also, in the second exemplary embodiment, as shown in FIG. 10, after the data communication is established between the image reading substrate 80 and the control substrate 82 through the DC lines 201 to 203 by the logic circuit 210 by detecting the PDN signal (the power ON control signal of the receiver), the HTPDN signal (the power ON detection signal of the receiver), and the LOCKN signal (the communication establishment detection signal), the LOCKN signal (the communication establishment detection signal) may be detected by the serial communication through the dedicated line 90. Once the data communication is established, the data communication is established by the serial communication through the dedicated line 90 on the basis of the LOCKN signal (the communication establishment detection signal). Accordingly, the influence of noise may be reduced.

### Third Exemplary Embodiment

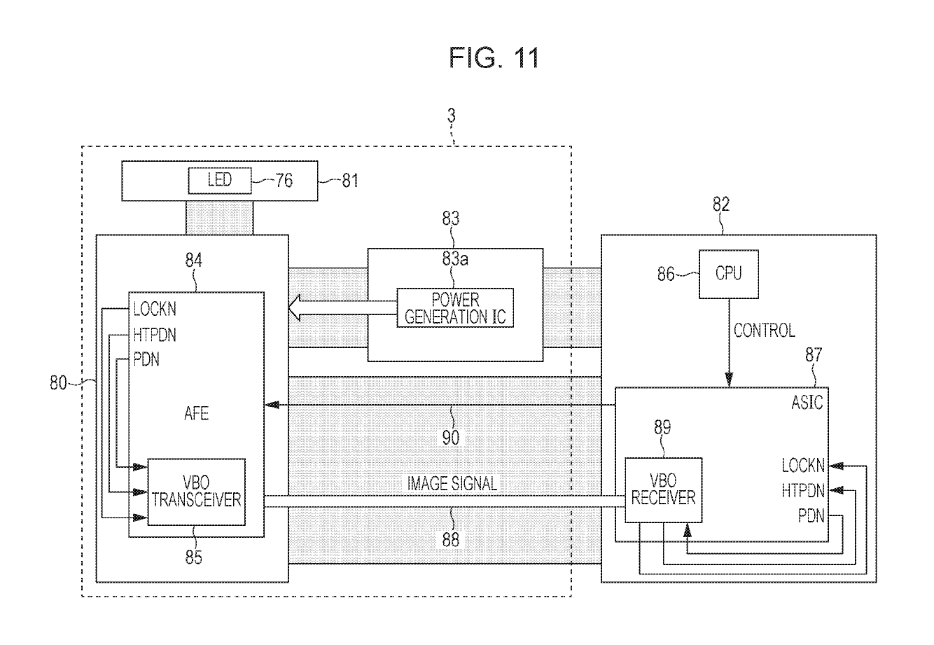

FIG. 11 is a block diagram showing an image reading device to which a data communication control device according to a third exemplary embodiment of the invention is applied.

In the third exemplary embodiment, as shown in FIG. 11, the VBO transceiver 85 is provided in the AFE 84, and hence the AFE 84 and the VBO transceiver 85 are integrated. The PDN signal, the HTPDN signal, and the LOCKN signal are input from the AFE 84 to the VBO transceiver 85.

Also, in the third exemplary embodiment, the VBO receiver 89 is provided in the ASIC 87, and hence the ASIC 87 and the VBO receiver 89 are integrated. The PDN signal is input from the ASIC 87 to the VBO receiver 89. Also, the HTPDN signal and the LOCKN signal are input from the VBO receiver 89 to the ASIC 87.

In the case of the third exemplary embodiment, by integrating the AFE 84 and the VBO transceiver 85 and integrating the ASIC 87 and the VBO receiver 89, the configurations of the image reading substrate 80 and the control substrate 82 are simplified.

### Fourth Exemplary Embodiment

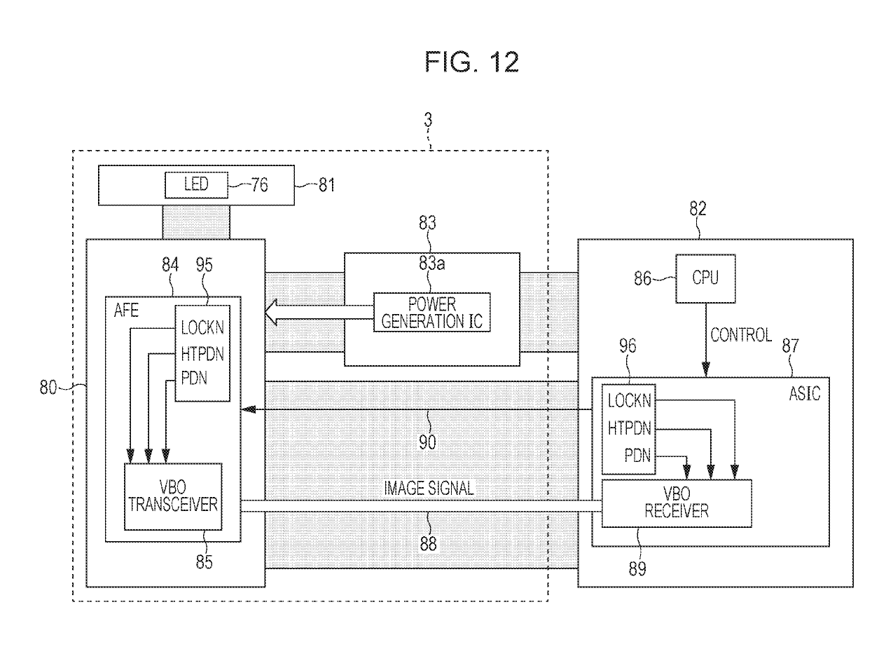

FIG. 12 is a block diagram showing an image reading device to which a data communication control device according to a fourth exemplary embodiment of the invention is applied.

In the fourth exemplary embodiment, as shown in FIG. 12, the VBO transceiver 85 is provided in the AFE 84, and hence the AFE 84 and the VBO transceiver 85 are integrated. In the AFE 84, the PDN signal, the HTPDN signal, and the LOCKN signal are notified to the VBO transceiver 85 through an inner circuit 95 (register control) by the serial communication without using an external circuit.

Also, in the fourth exemplary embodiment, the VBO receiver 89 is provided in the ASIC 87, and hence the ASIC 87 and the VBO receiver 89 are integrated. In the ASIC 87, the PDN signal, the HTPDN signal, and the LOCKN signal are input to the VBO receiver 89 through an inner circuit 96 (register control) without using an external circuit.

In the case of the fourth exemplary embodiment, by integrating the AFE 84 and the VBO transceiver 85 and integrating the ASIC 87 and the VBO receiver 89, the configurations of the image reading substrate 80 and the control substrate 82 are simplified. Also, since the PDN signal, the HTPDN signal, and the LOCKN signal are notified through the inner circuits 95 and 96 (register control) of the AFE 84 and the ASIC 87, superposition of noise or the like on the lines that transmit the PDN signal, the HTPDN signal, and the LOCKN signal may be restricted.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A data communication control device comprising:
a transmitting unit that transmits data; and
a receiving unit that receives the data through a communication line,
wherein the transmitting unit includes
a transmitting component that transmits an establishment signal of establishing communication to transmit the data to the receiving unit through the communication line, and
a first controller that controls the transmitting component,
wherein the receiving unit includes
a receiving component that receives the data transmitted by the transmitting component, and outputs a confirmation signal of confirming the establishment of the data communication with the transmitting component when receiving the establishment signal, and
a second controller that controls the receiving component, and transmits a notification signal of notifying the first controller about the establishment of the data communication through a dedicated line different from the communication line when receiving the confirmation signal input from the receiving component, and
wherein the transmitting component starts transmitting the data when the first controller receives the notification signal.

2. The data communication control device according to claim 1,
wherein the transmitting unit includes an output component that outputs at least one of the notification signal received by the first controller through the dedicated line and the confirmation signal output from the receiving component, and
wherein the transmitting component starts transmitting the data when receiving at least one of the notification signal and the confirmation signal output from the output component.

3. An image reading device comprising:
an image reading substrate that transmits image data; and
a control substrate that receives the image data through a communication line,
wherein the image reading substrate includes
a transmitting component that transmits an establishment signal of establishing communication to transmit the image data to the control substrate through the communication line, and
a first controller that controls the transmitting component,
wherein the control substrate includes
a receiving component that receives the image data transmitted by the transmitting component, and outputs a confirmation signal of confirming the establishment of the data communication with the transmitting component when receiving the establishment signal, and
a second controller that controls the receiving component, and transmits a notification signal of notifying the first controller about the establishment of the data communication through a dedicated line different from the communication line when receiving the confirmation signal input from the receiving component, and
wherein the transmitting component starts transmitting the image data when the first controller receives the notification signal.

4. The image reading device according to claim 3,
wherein the image reading substrate includes an output component that outputs at least one of the notification signal received by the first controller through the dedicated line and the confirmation signal output from the receiving component, and
wherein the transmitting component starts transmitting the image data when receiving at least one of the notification signal and the confirmation signal output from the output component.

5. The image reading device according to claim 3,
wherein the image reading substrate includes the transmitting component and the first controller in an integrated manner,
wherein the control substrate includes the receiving component and the second controller in an integrated manner,
wherein a signal is exchanged between the transmitting component and the first controller through a circuit on the image reading substrate, and
wherein a signal is exchanged between the receiving component and the second controller through a circuit on the control substrate.

6. The image reading device according to claim 3,
wherein the image reading substrate includes the transmitting component and the first controller in an integrated manner,
wherein the control substrate includes the receiving component and the second controller in an integrated manner,
wherein a signal is exchanged between the transmitting component and the first controller through an inner portion of the first controller, and
wherein a signal is exchanged between the receiving component and the second controller through an inner portion of the second controller.

7. An image forming apparatus comprising:
the image reading device according to claim 3; and
an image forming section that forms an image read by the image reading device, on a recording medium.
